(19) United States
(12) Patent Application Publication
(10) Pub. No.: US 2016/0100173 A1
(43) Pub. Date: Apr. 7, 2016

(54) Enhanced Video Streaming

(71) Applicant: INTERNATIONAL BUSINESS MACHINES CORPORATION, Armonk, NY (US)

(72) Inventors: Gerald F. McBrearty, Austin, TX (US); Johnny M. Shieh, Austin, TX (US)

(73) Assignee: INTERNATIONAL BUSINESS MACHINES CORPORATION, Armonk, NY (US)

(21) Appl. No.: 14/505,546

(22) Filed: Oct. 3, 2014

(51) Int. Cl. H04N 19/174; H04N 19/59; H04N 19/40

(52) U.S. Cl. CPC H04N 19/174; H04N 19/40; H04N 19/59

(57) ABSTRACT

Embodiments of the invention relate to improving functioning of a computer, and associated operating efficiency. An encoded video stream is separated into a plurality of segments, each segment having separate start and end times, and each segment having an original encoding resolution and associated size. At least one of the segments is selected and re-encoded at a resolution different than the original resolution. The re-encoded segment(s) has a data size less than the originally encoded segment. Transmission of the video stream with the re-encoded segment reduced data size of the transmission and reduces network bandwidth.

### BACKGROUND

The present invention relates to streaming a video file for viewing. More specifically, the invention relates to segregating the file into two or more segments and re-encoding one or more of the segments to enhance streaming of the file.

The original digital video recorders recorded data on a portable storage device, and the video was viewed on a visual display through a player. Technology has evolved where digital content is available through a computer server and network connection. This evolution allows consumers to view content in the comfort of their home to be viewed on their television or through a computing device, including a smart phone. When the content is selected to be viewed, it is generally not all downloaded on the receiving device. Rather, the data is preloaded into a reserved area of memory, referred to herein as a buffer. In streaming audio or video from a server, buffering refers to downloading a certain amount of data before starting to play the audio or video. Having an advance supply of audio or video frames in memory mitigates disruption if there is a delay in transmission while the data is being played.

When streaming data over the Internet, packets of data can traverse a plurality of routers from a source to a destination. Delays can be introduced at any junction in the streaming. For example, a message may be received during playback that the buffer is being filled but is not completely filled. When the buffer is completely filled, the audio or video file will start playing. Accordingly, there are junctures associated with content viewing that may result in a pause or other disruption when playing the file.

### SUMMARY

The invention includes a method, computer program product, and system for improving efficiency and reduced bandwidth associated with transmission of data.

A method, computer program product, and system are provided for improving function of a computer, and more specifically, to reducing bandwidth of data transmission. An encoded data stream is divided into two of more time slices. Each slice pertains to a separate segment within the stream, and both a separate start time and end time for each segment are identified. Specifically, a first time slice is identified with a first start time and a first end time, and a second time slice is identified with a second start time and a second end time. The first segment is encoded at a first data resolution, with a first original data size associated with the first resolution. Similarly, the second segment is encoded at a second data resolution, with the second original data size associated with the second resolution. A size of the encoded stream is reduced. More specifically, one of the first and second segments is identified or otherwise designated for re-encoding at a second resolution. Following the designated, the segment is re-encoded at a second resolution, with a re-encoded data size less than an associated original data size. Transmission of the re-encoded time slice with a reduced data size reduces network bandwidth.

Other features and advantages of this invention will become apparent form the following detailed description of the presently preferred embodiment(s) of the invention, taken in conjunction with the accompanying drawings.

### BRIEF DESCRIPTION OF THE SEVERAL VIEWS OF THE DRAWINGS

The drawings referenced herein form a part of the specification. Features shown in the drawings are meant as illustrative of only some embodiments of the invention, and not of all embodiments of the invention unless otherwise explicitly indicated.

FIG. 1 depicts a flow chart illustrating a process for receiving and indexing a video stream.

FIG. 2 depicts a flow chart illustrating a process for re-encoding one or more segments in a multi-segment video stream.

FIG. 3 depicts a flow chart illustrating a process for streaming the video with one or more re-encoded segments.

FIG. 4 depicts a flow chart illustrating a process for identifying each segment in the index, including an associated segment size and resolution.

FIG. 5 depicts a block diagram of a multi-segment video stream.

FIG. 6 depicts a block diagram of a multi-segment video stream with at least one segment re-encoded.

FIG. 7 depicts a block diagram of a system to enhance video streaming.

FIG. 8 depicts a block diagram showing a system for implementing an embodiment of the present invention.

### DETAILED DESCRIPTION

It will be readily understood that the components of the present invention, as generally described and illustrated in the Figures herein, may be arranged and designed in a wide variety of different configurations. Thus, the following detailed description of the embodiments of the apparatus, system, and method of the present invention, as presented in the Figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearances of the phrases “a select embodiment,” “in one embodiment,” or “in an embodiment” in various places throughout this specification are not necessarily referring to the same embodiment.

The illustrated embodiments of the invention will be best understood by reference to the drawings, wherein like parts are designated by like numerals throughout. The following description is intended only by way of example, and simply illustrates certain selected embodiments of devices, systems, and processes that are consistent with the invention as claimed herein.

A video is a recordation, reproduction, or broadcast of moving visual images. All videos have an associated resolution, which refers to the sharpness and clarity of an image, and often, but not always, represented by the number of distinct lines or pixels in each dimension that can be displayed. More specifically, in analog or digital images resolution is the term used to describe the number of lines, dots or pixels in each dimension, including two and three dimensional images, used to display an image. Higher resolutions mean that more pixels are used to create the image, resulting in a crisper and cleaner image. At the same time, the higher resolution video utilizes more computing resources than a video with a lower resolution.

Videos may be viewed via download or streaming. A downloaded video is transmitted from one computer system to another, and following the transmission is available for viewing. Video streaming refers to the process of playing sound or video in real time as it is downloaded over a network. The process of streaming video removes the process of sending the video as a file, downloading the received file, and opening the file. High bandwidth network connections are generally needed to work with streaming video. Specific bandwidth requirements depend on the type of content. For example, high resolution streaming video requires more bandwidth than low resolution video. The bandwidth of a media stream is its bit rate. Dropped video frames and/or loss of sound results if the bit rate being maintained on the network for a stream drops below the rate needed to support immediate playback.

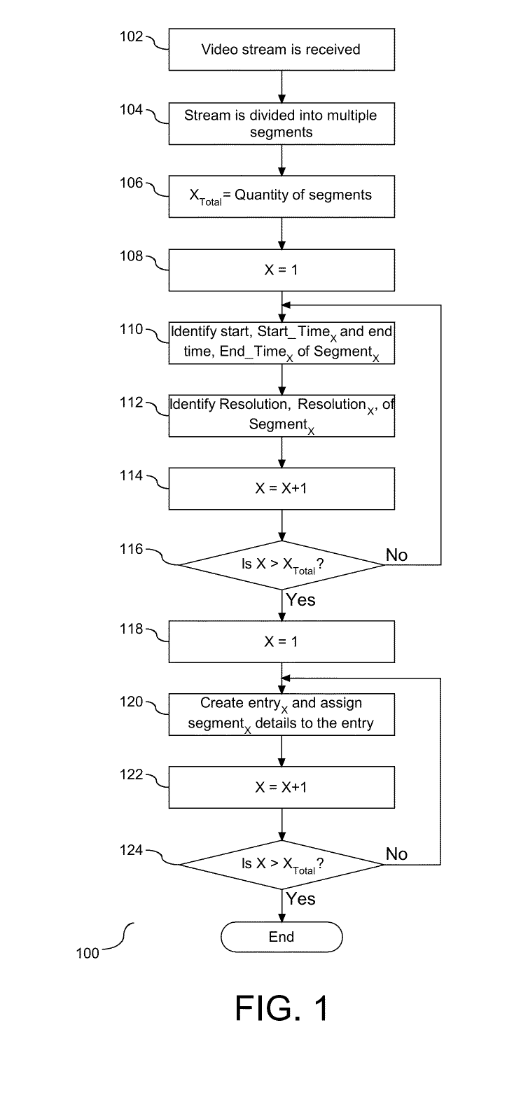

Referring to FIG. 1, a flow chart (100) is provided illustrating a process for receiving and indexing a video stream. As shown, a video stream is received (102) and prepared for segmentation and indexing. The stream is divided into multiple segments (104). The segmentation may be based on division of content within the video, time intervals, or other factors. Regardless of the basis of the segmentation, the variable X_{Total} is assigned to the quantity of segments (106) and an associated segment counting variable, X, is initialized (108). The start time, start_timeₓ and end time, end_timeₓ, of segmentₓ are identified (110). In addition, the resolution, resolutionₓ, of segmentₓ is identified (112). Following step (112), the segment counting variable, X, is incremented (114), and it is then determined if all of the segments have been identified (116). A negative response to the determination at step (116) is followed by a return to step (110) for further processing of the stream. However, a positive response to the determination at step (116) is an indication that details of each segment have been identified, including start time, end time, and resolution.

Following the process of gathering segment details, an index of the segments is created. As shown, the segment counting variable X is initialized (118), and details of each segment are entered and organized within the index. More specifically, an index entry is created and identified as index_entryₓ, and details of segmentₓ are assigned to the respective index entry, includes, the start time, start_timeₓ, end time, end_timeₓ, and resolution, resolutionₓ. with an entry for the size of the segment (120). Following the index entry creation at step (120), the segment counting variable X is incremented (122), and it is determined if all of the segments and their associated details have been entered in the index (124). A negative response to the determination at step (124) is followed by a return to step (120), and a positive response concludes the organization of the index. Accordingly, as shown herein the video stream is segmented and organized in an associated index.

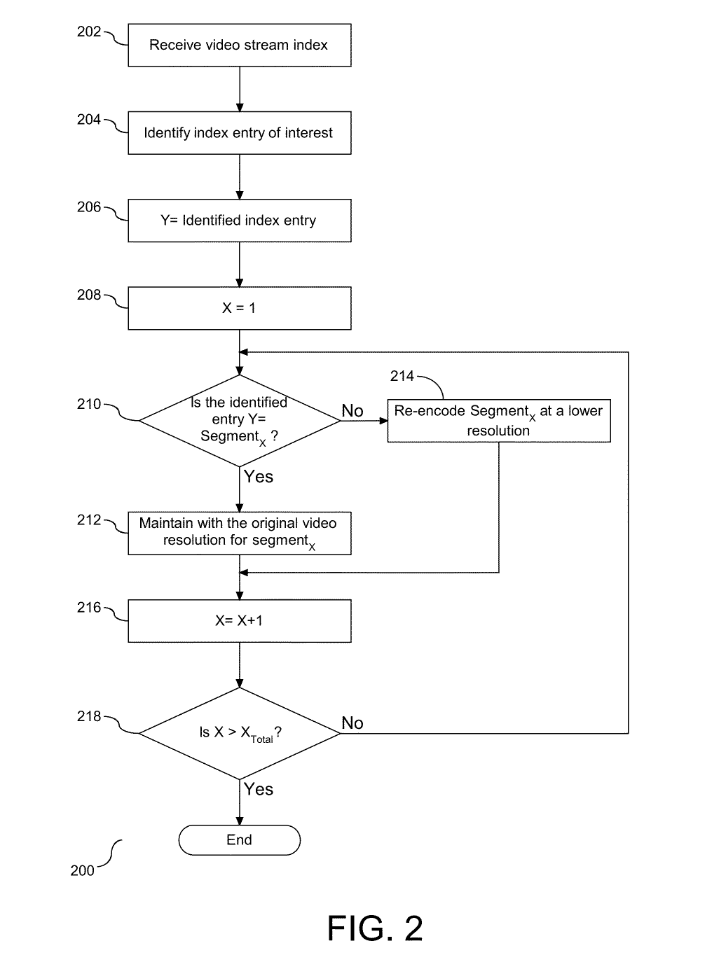

As shown in FIG. 1, a video stream is segmented. The size of the segments may be homogenous or heterogeneous. However, because the stream is segmented, a person viewing the stream may identify one or more specific segments for viewing. Referring to FIG. 2, a flow chart (200) is provided illustrating a process for re-encoding one or more segments in a multi-segment video stream. More specifically, the re-encoding pertains to a received high resolution video that is processed to reduce the resolution size of one or more of the stream segments. By lowering the resolution, the stream will require less bandwidth for transmission, and with respect to storage, will require less data storage. As shown, the video stream index is reviewed (202), and an index entry of interest is identified (204). The variable Y is assigned to the identified index entry (206). As shown in FIG. 1, the quantity of segmented stream entries is defined as X_{Total}, with X representing the segment counting variable and in one embodiment the segment index entries. As shown in FIG. 2, the segment counting variable is initialized (208), and it is determined if the identified index entry, Y, is segmentₓ (210). The re-encoding process maintains the original resolution for the identified segment. As such, a positive response to the determination at step (210) is followed by designating segmentₓ to be maintained with the original video resolution (212).

The goal of the re-encoding is to enhance transmission of the video and, more specifically, to support and enable efficiency use of computing resources for transmission of the video in a manner that utilizes less bandwidth. A negative response to the determination at step (210) re-encodes the identified segment of interest at a lower resolution than the original segment resolution (214). This re-encoding lowers bandwidth associated with transmission of the re-encoded segment. Following either step (212) or (214), the segment counting variable is incremented (216). It is then determined if all of the identified segments in the stream have been reviewed for re-encoding in view of the segment associated with the identified index entry (218). A negative response to the determination at step (218) is followed by a return to step (210), and a positive response concludes the re-encoding process. Accordingly, one or more segments in the stream are re-encoded at a resolution lower than the original resolution of the segment so that the selected segment(s) have a smaller data size than an associated original data size.

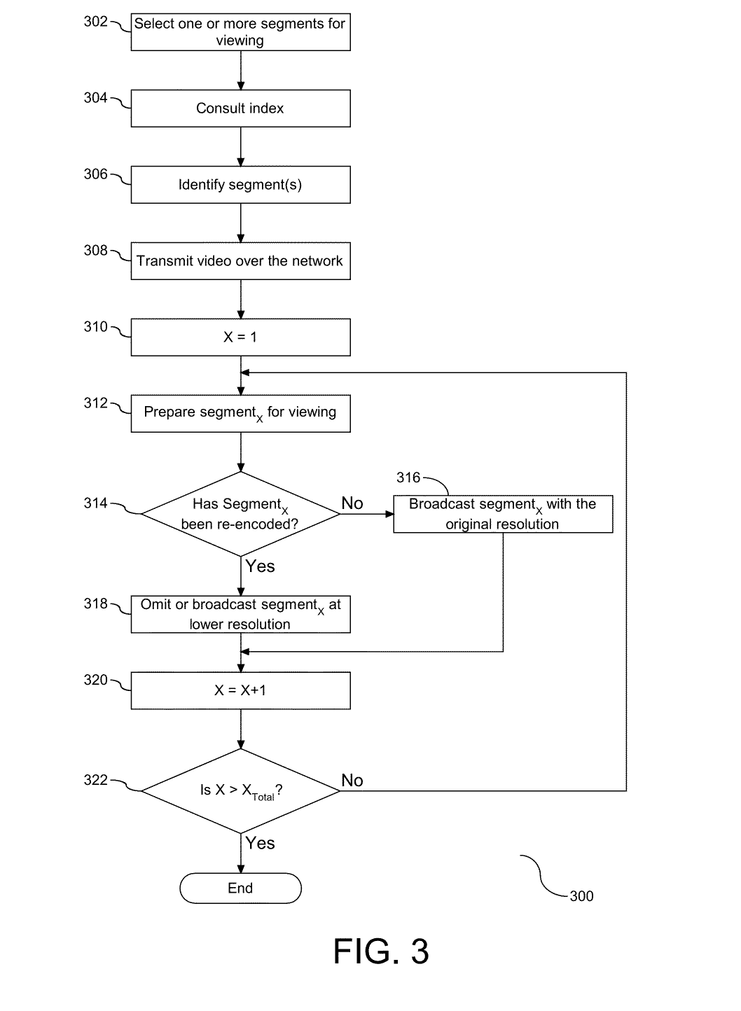

In streaming video, buffering refers to downloading a certain amount of data before starting to play the video. Referring to FIG. 3, a flow chart (300) is provided illustrating a process of streaming the video with one or more re-encoded segments. The video may be streamed in its entirety with the higher resolution segments limited to one or more selected segments, thereby reducing the bandwidth of the entirety of the video transmission. As the viewer has pre-designated the segment(s) of interest, those segments are maintained at a higher resolution and will have enhanced viewing characteristics. In another embodiment, the viewer of the video may omit the re-encoded segments from viewing. Since the re-encoded segments are encoded with a lower resolution, they require less buffering than the higher resolution segment(s). As shown herein, one or more segments are selected to be viewed (302). Since the segments have been indexed, as shown in FIG. 1, the index is consulted (304), and the segment(s) are identified (306). The video is transmitted over the network for viewing (308).

As shown and described in FIG. 2, one or more segments may have a modified resolution indicating that these segments are not of interest for broadcast or viewing. These identified segments may be omitted from viewing or may be broadcast with a lower resolution thereby affecting the quality of the broadcast. As shown, the segment counting variable, X, is initialized (310), and segmentₓ is prepared for viewing (312). It is determined if segmentₓ has been re-encoded (314). If the segment being reviewed was not re-encoded, the segment, segmentₓ, is broadcast with the original resolution (316). However, if the segment being reviewed was re-encoded, the segment, segmentₓ, is omitted from broadcasting or broadcast at the lower resolution (318). In one embodiment, the decision to omit select segments from broadcast or to broadcast at a lower resolution is a setting designated prior to transmission of the video. Following either step (316) or step (318), the segment counting variable is incremented (320), and it is determined if all of the segments in the video being broadcast or transmitted have been reviewed (322). A negative response to the determination at step (322) is followed by a return to step (312), and a positive response concludes the video streaming process. Accordingly, selection of one or more segments improves functioning of machine efficiency with respect to transmission of data, and specifically reducing bandwidth across network resources.

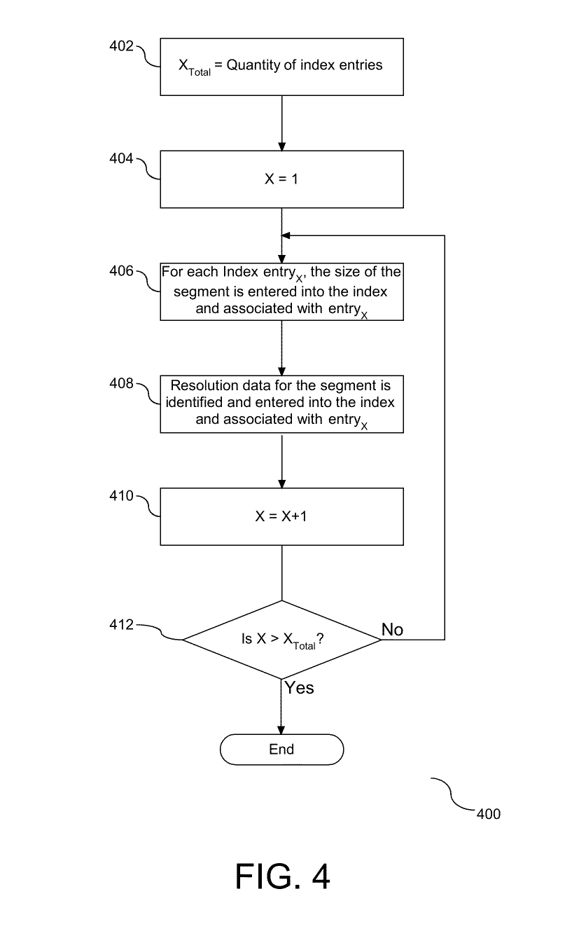

As shown and described herein, the video stream is separated into segments, with each of the segments identified in an associated index. See FIG. 1 for details of segment indexing. The index may be amended to reflect changes to one or more segments. Referring to FIG. 4, a flow chart (400) is provided illustrating a process for identifying each segment in the index, including an associated segment size and resolution. The variable X_{Total} refers to the quantity of index entries (402), with each entry referred to as a video stream segment. An index counting variable X is initialized (404). For each index entryₓ, the size of the segment is entered into the index and associated with entryₓ (406). In addition, resolution data for the segment is identified and entered into the index and associated with entryₓ (408). Following step (408), the index entry counting variable is incremented (410), and it is determined if all of the index entries have been identified and updated (412). A negative response to the determination at step (412) is followed by a return to step (406), and a positive response concludes amending the index entries. Accordingly, each segment is identified in the index, with each index entry including size and resolution data associated with the segment.

The process of entering size and resolution data into the index may take place when the index is created. In one embodiment, the process shown and described in FIG. 4 may take place after one or more segments in the video stream are re-encoded, so that the index reflects any changes to the segments and the associated video stream. In another embodiment, the process shown and described in FIG. 4 may be incorporated into the segment re-encoding process shown and described in FIG. 2.

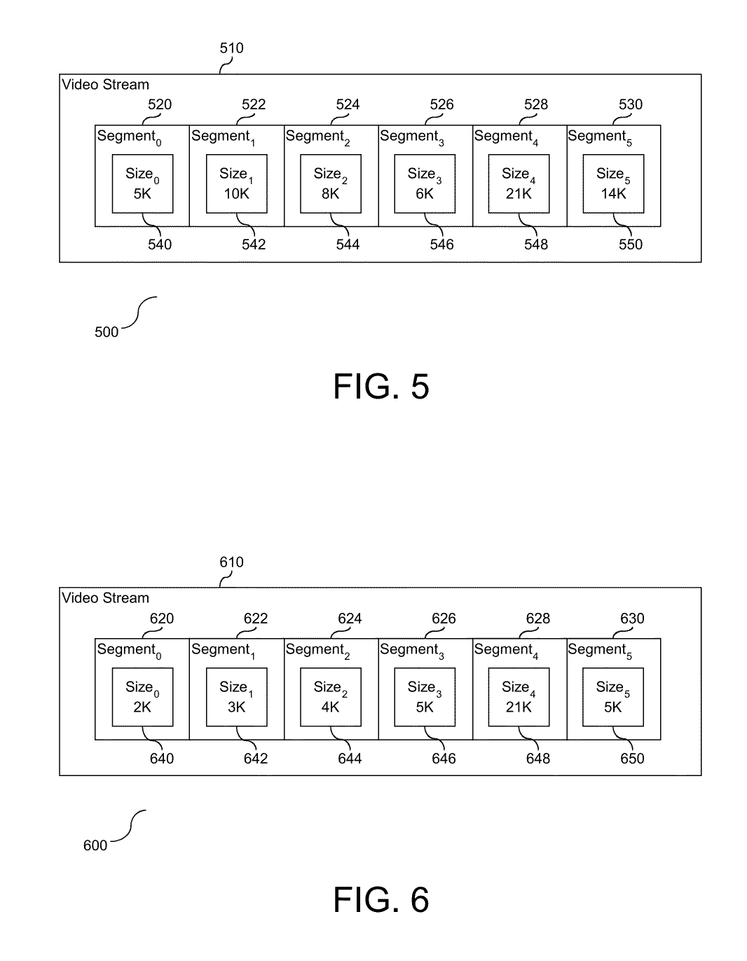

Referring to FIG. 5, a block diagram (500) of a multi-segment video stream is provided. As shown, the video stream (510) is separated into six segments, referred to herein as segment° (520), segment₁ (522), segment₂ (524), segment₃ (526), segment₄ (528), and segment₅ (530). Each segment is shown with an associated size, referred to herein as size° (540), size₁ (542), size₂ (544), size₃ (546), size₄ (548), and size₅ (550). The segment quantity and associated sizes are examples. In one embodiment, the video stream may have a different quantity of segments than those shown herein, and the sizes for the identified segments may vary, and as such should not be considered limiting. Accordingly, each segment includes size data representative of data encoded to display in a designated format.

Referring to FIG. 6, a block diagram (600) of a multi-segment video stream is provided with at least one segment re-encoded. Similar to video stream (510), video stream (610) is separated into six segments, referred to herein as segment° (620), segment₁ (622), segment₂ (624), segment₃ (626), segment₄ (628), and segment₅ (630). Each segment is shown with an associated size, referred to herein as size° (640), size₁ (642), size₂ (644), size₃ (646), size₄ (648), and size₅ (650). As shown in this representative example, segments (620), (622), (624), (626), and (630) are each shown with a data size that is both different and smaller than their original data size. At the same time, segment₄ (628) is shown with the original size maintained. Accordingly, in the example shown herein, except for segment₄ (628), each of the segments are re-encoded to a smaller size and a lower resolution.

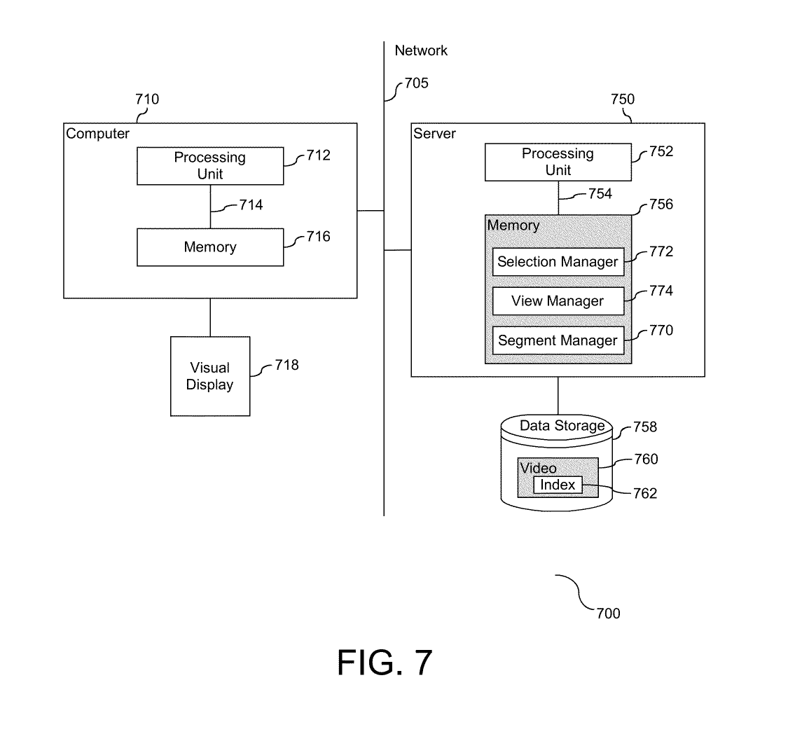

As shown in FIGS. 1-6, video streams are segments, and select segments are identified and re-encoded to support efficiency of transmission and streaming. Referring to FIG. 7, a block diagram (700) is provided depicting a system for enhancing video streaming. The system (700) is shown with a computer (710) provided with a processing unit (712) in communication with memory (716) across a bus (714), and a visual display (718). The computer (710) is in communication with one or more additional machines (750), referred to herein as a server, across a network connection. In one embodiment, the server (750) is provided with a processing unit (752) in communication with memory (756) across a bus (754), and data storage (758). Data, such as video (760), may be streamed from the server (750) to the computer (710), also referred to herein as a client machine, across a network connection (705). To support efficiency associated with the streaming, a segment manager (770) and associated selection manager (772) and view manager (774), hereinafter referred to collectively as tools, are provided to manage the video (760). More specifically, the tools (770), (772), and (774) support the functionality of dividing the stream into multiple segments and associated transmission and broadcast of the segmented stream, as shown and described in FIGS. 1-6.

The video (760) may be pre-configured and segmented based upon content, or alternative or additional criteria. At the same time, the video (760) may not be pre-configured. In the case of the video that is not pre-configured, the segment manager (770) functions to separate or otherwise divide the video into a plurality of segments, as shown in FIGS. 5 and 6. Once the video has been configured, or in some cases, pre-configured, the segment manager (770) identifies a start time and an end time for each of the individual segments, and an original data resolution for each of the individual segments. In one embodiment, the segment manager (770) creates an index (762) for the video (760). The index (762) includes a set of entries, with one entry for each of the video segments. In addition, the index (762) includes one or more fields for each entry, with the field(s) including the size of the associated segment. In one embodiment, the index (762) includes an additional field directed to the start and end time for the associated segment. Once the segment manager (770) has segmented and organized the video, the selection manager (772) selects at least one of the individual segments and the segment manager (770) re-encodes the selected segment(s) at a second resolution, which is different than the original resolution. Specifically, the re-encoded segment is encoded with a resolution that has a data size less than the original resolution. Accordingly, the segmentation and re-encoding of selected segments takes place prior to viewing the video.

The view manager (774) is provided in communication with the segment manager (770). The view manager (774) functions to support and enable viewing of the video following the re-encoding of one or more selected segments. The view manager (774) designates or otherwise selects the segment(s) of the video that they are interested in viewing. These segments may include re-encoded segments, or segments encoded at their original size and resolution. Based on the designation, the segment manager (770) streams the selected or designated segment(s) to the computer (710). As described above, the segment manager (770) re-encodes one or more segments of the video at a lower resolution, thereby reducing storage space and reducing viewing quality of the re-encoded segment(s). At the time of streaming the video to be viewed, the segment (770) may omit the re-encoded segments or broadcast the re-encoded segments, thereby focusing the view on segments containing the original resolution.

The server described above in FIG. 7 has been labeled with tools (770), (772), and (774), to facilitate and enable efficient transmission and viewing of video data. The tools may be implemented in programmable hardware devices such as field programmable gate arrays, programmable array logic, programmable logic devices, or the like. The tools may also be implemented in software for execution by various types of processors. An identified functional unit of executable code may, for instance, comprise one or more physical or logical blocks of computer instructions which may, for instance, be organized as an object, procedure, function, or other construct. Nevertheless, the executable of the tools need not be physically located together, but may comprise disparate instructions stored in different locations which, when joined logically together, comprise the tools and achieve the stated purpose of the tool.

Indeed, executable code could be a single instruction, or many instructions, and may even be distributed over several different code segments, among different applications, and across several memory devices. Similarly, operational data may be identified and illustrated herein within the tool, and may be embodied in any suitable form and organized within any suitable type of data structure. The operational data may be collected as a single data set, or may be distributed over different locations including over different storage devices, and may exist, at least partially, as electronic signals on a system or network.

Furthermore, the described features, structures, or characteristics may be combined in any suitable manner in one or more embodiments. In the following description, numerous specific details are provided, such as examples of agents, to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

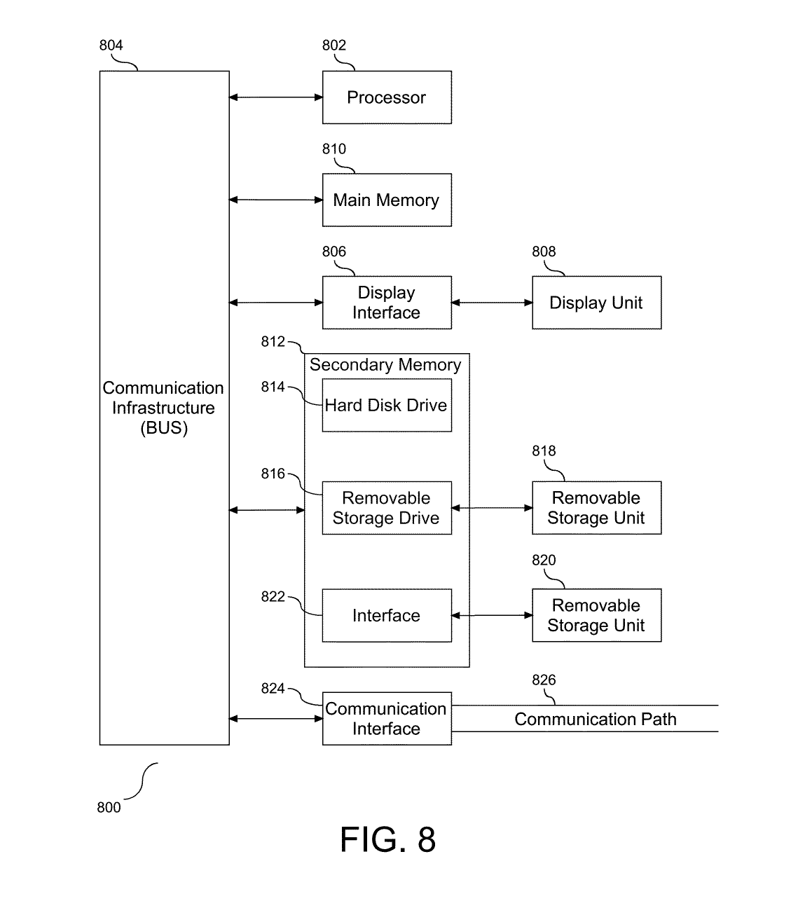

Referring now to the block diagram of FIG. 8, additional details are now described with respect to implementing an embodiment of the present invention. The computer system includes one or more processors, such as a processor (802). The processor (802) is connected to a communication infrastructure (804) (e.g., a communications bus, cross-over bar, or network).

The computer system can include a display interface (806) that forwards graphics, text, and other data from the communication infrastructure (804) (or from a frame buffer not shown) for display on a display unit (808). The computer system also includes a main memory (810), preferably random access memory (RAM), and may also include a secondary memory (812). The secondary memory (812) may include, for example, a hard disk drive (814) and/or a removable storage drive (816), representing, for example, a floppy disk drive, a magnetic tape drive, or an optical disk drive. The removable storage drive (816) reads from and/or writes to a removable storage unit (818) in a manner well known to those having ordinary skill in the art. Removable storage unit (818) represents, for example, a floppy disk, a compact disc, a magnetic tape, or an optical disk, etc., which is read by and written to by removable storage drive (816).

In alternative embodiments, the secondary memory (812) may include other similar means for allowing computer programs or other instructions to be loaded into the computer system. Such means may include, for example, a removable storage unit (820) and an interface (822). Examples of such means may include a program package and package interface (such as that found in video game devices), a removable memory chip (such as an EPROM, or PROM) and associated socket, and other removable storage units (820) and interfaces (822) which allow software and data to be transferred from the removable storage unit (820) to the computer system.

The computer system may also include a communications interface (824). Communications interface (824) allows software and data to be transferred between the computer system and external devices. Examples of communications interface (824) may include a modem, a network interface (such as an Ethernet card), a communications port, or a PCMCIA slot and card, etc. Software and data transferred via communications interface (824) is in the form of signals which may be, for example, electronic, electromagnetic, optical, or other signals capable of being received by communications interface (824). These signals are provided to communications interface (824) via a communications path (i.e., channel) (826). This communications path (826) carries signals and may be implemented using wire or cable, fiber optics, a phone line, a cellular phone link, a radio frequency (RF) link, and/or other communication channels.

In this document, the terms “computer program medium,” “computer usable medium,” and “computer readable medium” are used to generally refer to media such as main memory (810) and secondary memory (812), removable storage drive (816), and a hard disk installed in hard disk drive (814).

Computer programs (also called computer control logic) are stored in main memory (810) and/or secondary memory (812). Computer programs may also be received via a communication interface (824). Such computer programs, when run, enable the computer system to perform the features of the present invention as discussed herein. In particular, the computer programs, when run, enable the processor (802) to perform the features of the computer system. Accordingly, such computer programs represent controllers of the computer system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the functions/acts specified in the flowcharts and/or block diagrams block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowcharts and/or block diagrams block or blocks.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated. The implementation of one or more segments of a video files configured at a different resolution(s) supports improvement of machine efficiency. Specifically, the reduced resolution provides reduced data for transmission and broadcast, thereby utilizing fewer computing resources and reducing bandwidth of data transmission. Accordingly, the modification of one or more data file segments continues to enables transmission of the file, while providing faster viewing, and/or reduced bandwidth associated with transmission of the video.

It will be appreciated that, although specific embodiments of the invention have been described herein for purposes of illustration, various modifications may be made without departing from the spirit and scope of the invention. In particular, the video file demonstrated herein may be replaced with a data file in the form of still images, or alternate data formats to support and enable reduced data storage and associated transmission of the data across a network. Similarly, in one embodiment, the non-selected segment(s) is re-encoded at a different resolution to occupy a smaller footprint, with the video or data transmission to include both the original segment(s) and the re-encoded segment(s). Accordingly, the scope of protection of this invention is limited only by the following claims and their equivalents.

We claim:

1. A method comprising:
dividing an encoded video stream into a plurality of slices, each slice have a separate start time and end time, including a first time slice with a first start time and a first end time, and a second time slice with a second start time and a second end time, the first and second time slices encoded at a first data resolution, wherein the first time slice has a first original data size associated with the first resolution and the second time slice has a second original data size associated with the second resolution;
reducing a data size of the encoded video stream, including selecting one of the first and second time slices for re-encoding at a second resolution; and
re-encoding the selected time slice at the second video resolution, wherein the re-encoded time slice has a re-encoded data size less than an associated original data size, and wherein transmission of the re-encoded time slice with a reduced data size reduces network bandwidth.

2. The method of claim 1, further comprising selecting one of the first and second time slices for viewing, wherein the selection includes the re-encoded time slice.

3. The method of claim 2, further comprising streaming the selected time slice with an encoded resolution, including one of the first and second resolutions.

4. The method of claim 3, wherein the streaming of the selected time slice includes omitting the re-encoded time slice.

5. The method of claim 1, further comprising indexing the time slices, including a first index entry for the first time slice and a second index entry for the second time slice, the first index entry representing a first size of the first slice and the second index entry representing a second size of the second slice.

6. The method of claim 5, wherein each index entry includes video resolution data for the time slice.

7. A computer program product for enhancing a video stream, the computer program product comprising a computer readable storage device having program code embodied therewith, the program code executable of a processing unit to:
divide an encoded video stream into a plurality of slices, each slice have a separate start time and end time, including a first time slice with a first start time and a first end time, and a second time slice with a second start time and a second end time, the first and second time slices encoded at a first data resolution, wherein the first time slice has a first original data size associated with the first resolution and the second time slice has a second original data size associated with the second resolution;
reduce a data size of the encoded video stream, including selection of one of the first and second time slices for re-encoding at a second resolution;
re-encode the selected time slice at the second video resolution, wherein the re-encoded time slice has a re-encoded data size less than an associated original data size, and wherein transmission of the re-encoded time slice with a reduced data size reduces network bandwidth.

8. The computer program product of claim 7, further comprising selection of one of the first and second time slices for viewing, wherein the selection includes the re-encoded time slice.

9. The computer program product of claim 8, further comprising program code to stream the selected time slice with an encoded resolution, including one of the first and second resolutions.

10. The computer program product of claim 9, wherein the streaming of the selected time slice includes program code to omit the re-encoded time slice.

11. The computer program product of claim 7, further comprising program code to index the time slices, including a first index entry for the first time slice and a second index entry for the second time slice, the first index entry representing a first size of the first slice and the second index entry representing a second size of the second slice.

12. The computer program product of claim 11, wherein each index entry includes video resolution data for the time slice.

13. A system comprising:
a processing unit in communication with memory;
a segment manager in communication with the processing unit, the segment manager to divide an encoded video stream into a plurality of segments, each segment have a separate start time and end time, including a first segment with a first start time and a first end time, and a second segment with a second start time and a second end time, the first and second segments having an original encoding at a first data resolution, wherein the first segment has a first original data size associated with the first resolution and the second segment has a second original data size associated with the second resolution;
the segment manager to reduce a data size of the encoded video stream, including a selection manager in communication with the segment manager, the selection manager to select one of the first and second segments for re-encoding at a second resolution; and
the segment manager to re-encode the selected segment at the second video resolution, wherein the re-encoded segment has a re-encoded data size less than an associated original data size, and wherein transmission of the re-encoded time slice with a reduced data size reduces network bandwidth.

14. The system of claim 13, further comprising a view manager in communication with the segment manager, the view manager to select one of the first and second segments, wherein the selection includes the re-encoded segment.

15. The system of claim 14, further comprising the tool to stream the selected segment with an encoded resolution, including one of the first and second resolutions.

16. The system of claim 15, further comprising the segment manager to omit the re-encoded segment when streaming the selected segment.

17. The system of claim 13, further comprising the segment manager to index the segments, including a first index entry for the first segment and a second index entry for the second segment, the first index entry representing a first size of the first segment and the second index entry representing a second size of the second segment.

18. The system of claim 17, wherein each index entry includes video resolution data for the segment.
